(19) United States
(12) Patent Application Publication
(10) Pub. No.: US 2026/0070634 A1
(43) Pub. Date: Mar. 12, 2026

(54) METHOD FOR COUNTERBALANCING MEAN INCLINATION OF A FLOATING WIND TURBINE PLATFORM

(71) Applicant: Jun Zou, Houston, TX (US)

(72) Inventor: Jun Zou, Houston, TX (US)

(21) Appl. No.: 18/829,284

(22) Filed: Sep. 10, 2024

(51) Int. Cl. B63B 39/03; B63B 35/44; B63B 79/10; F03D 13/25

(52) U.S. Cl. CPC B63B 39/03; B63B 35/44; B63B 79/10; F03D 13/256; B63B 2035/446; F05B 2240/93; F05B 2240/95

(57) ABSTRACT

The method for counterbalancing the mean inclination of a Floating Offshore Wind Turbine (FOWT) platform is designed to be simple, efficient, and highly responsive. It employs short-distance piping to enable swift and effective pump-in and pump-out operations within the same column, allowing for precise and independent control of ballast operation. This strategy is not only cost-efficient but also supports remote operation, facilitating rapid adjustments for both normal and abnormal conditions. Furthermore, the method incorporates redundancy in the counterbalancing systems, significantly boosting the overall reliability and ensuring consistent and effective ballast management for the platform.

### BACKGROUND

A floating wind turbine platform features a buoyant foundation supporting a tower, which includes a nacelle and a set of blades. The buoyant foundations are generally classified into four types: Spar platforms, Semi-submersible (SEMI) platforms, Barge platforms, and Tension Leg Platforms (TLPs). Stability for Spar, Semi, and Barge platforms is primarily ensured through the hydrostatic stiffness of their foundation configurations, whereas TLPs rely mainly on vertical mooring systems for their stability.

One of the most advanced and promising concepts is the semi-submersible platform. To significantly reduce the Levelized Cost of Energy (LCOE) for floating wind farms, employing high-capacity wind turbines is highly effective. Turbine sizes have rapidly increased from 5 MW to 15 MW in recent years. Table 1 summarizes the hub heights, rated thrust loads (RTL), and overturning moments (OM) for 5 MW, 10 MW, and 15 MW wind turbines, along with their corresponding ratios. All measurements for hub heights and overturning moments are with respect to (w.r.t.) the mean water level (MWL).

TABLE 1

| | Hub | | | | | |
|---|---|---|---|---|---|---|
| | Heights | | OMs | Ratio | | |
| WTG | w.r.t. | | w.r.t. | of WTG | Ratio of | Ratio of |
| Capacity | MWL | RTLs | MWL | Capacities | RTLs | OMs |
| (MW) | (m) | (KN) | (KN-m) | % | % | % |
| 5 | 90 | 790 | 71,100 | 100 | 100 | 100 |
| 10 | 119 | 1,525 | 181,475 | 200 | 193 | 255 |
| 15 | 150 | 2,750 | 412,500 | 300 | 348 | 580 |

From Table 1, the ratio of rated thrust loads closely matches the ratio of wind turbine generator (WTG) capacities, while the ratio of overturning moments shows a significantly sharper increase. This indicates that floating wind turbine platforms will experience substantial mean inclination due to the sharp rise in overturning moments during operation. The increase in overturning moments is expected to become even steeper as WTG capacities rise from 15 MW to 20 MW or more. Effectively addressing the large mean inclination will become a more pressing challenge as higher-capacity WTGs are employed to reduce LCOE in future wind farm developments.

As an example, thrust loads and corresponding overturning moments for a 15 MW WTG as a function of wind speed are plotted in FIG. 1. When the wind speed reaches 7 m/s, both thrust loads and overturning moments increase sharply, peaking at the rated wind speed. They then decrease steeply immediately after the wind speed exceeds the rated value and continue to decrease moderately from 13 m/s to 25 m/s. Without counteracting overturning moments during normal operations, the floating offshore wind turbine (FOWT) platform will experience significant inclinations, which will substantially affect the power production efficiency of the WTG.

There are at least four scenarios where the FOWT platform will experience large inclinations during its field service life (20-30 years): 1) During normal operations, when the incident wind speed at hub height exceeds 7 m/s, both the thrust loads and the corresponding overturning moments increase sharply. Especially when the wind speed reaches the rated speed, the WTG experiences peak thrust loads and overturning moments, as shown in FIG. 1; 2) If the wind speed at hub elevation exceeds 25 m/s, the WTG will park and remain idle. To meet class society requirements, the FOWT platform must be designed for 50-year events as design extreme cases. For a robust design check, survivability in 500-year events is also required. In some sites, the wind speed for a 50-year event is considerably higher than 25 m/s, and the corresponding overturning moments exceed those induced by the rated thrust loads. The situation worsens when checking against a 500-year event; 3) If one tank of the hull is damaged and flooded in a calm sea state, a large amount of water will enter the tank. The platform will lose buoyancy, resulting in a deeper draft, and the flooded water will induce significant overturning moments, causing the FOWT platform to tilt by more than 10 degrees. The situation worsens if environmental conditions (wave and wind) are not calm; 4) During an emergency shutdown in a calm sea state, the WTG must be shut down within a short duration, say 1-3 minutes. The tilt of the FOWT platform may be 5-10 degrees during the emergency shutdown. The situation worsens if environmental conditions (wave and wind) are not calm. To address these challenges, reliable and economical methods for counterbalancing mean inclinations are urgently needed.

As shown in FIG. 2, a diagram of the ballast transfer system is proposed and presented. Several shortcomings are highlighted: a) The internal active ballast system transfers ballast from one column to another. Given the large volume of water transfer, this process takes about 15 to 30 minutes, which is relatively slow, especially during abnormal conditions such as a flooded tank or an emergency shutdown. This delay could affect the platform's stability and performance; b) A substantial amount of water ballast is pumped and transferred from one column to another through the upper horizontal main trusses. This process involves lengthy pipelines that are expensive and require higher maintenance costs. The system also consumes energy to operate the pumps and maintain ballast levels, which can increase the platform's overall energy consumption and impact its efficiency and LCOE; c) With the application of larger wind turbines, such as a 15 MW turbine, the column span must increase significantly to meet stability requirements. This implies a considerable increase in the length of pipelines and the amount of water needed for ballast transfer. Consequently, costs, response times, and power consumption for correcting rotation will rise; d) Reliability is a concern as the system depends heavily on mechanical and electrical components, which can be prone to failure. A failure in the trim system could compromise the stability of the entire platform and e) Higher initial investment is another barrier. The design, installation, and integration of a closed-loop ballast system can be more expensive compared to simpler ballast solutions, impacting the overall budget of the project. Thus, the weaknesses of the ballast transfer system become more severe and pronounced.

The industry is striving to halve the LCOE within a stringent timeline, aiming to lower economic barriers and expedite the transition from conventional energy sources. The cost of wind energy remains significantly higher than that of traditional power, creating a substantial economic barrier. To address this challenge, the industry is committed to reducing costs from every aspect of the design. Overcoming the disadvantages of the ballast system described earlier is crucial for reducing costs, improving reliability, making floating offshore wind turbines (FOWTs) more competitive, and accelerating the shift towards more sustainable energy sources.

This invention aims to eliminate the need for long-distance ballast transfer between columns, as illustrated in FIG. 2. The method in this embodiment controls the addition and removal of ballast water within the same column, guided by commands from the central control system. This technique guarantees a swift response time, offers simplicity in operation, requires minimal maintenance, utilizes proven technology, ensures an inherently safe design, and provides the best overall value for its anticipated design life of twenty to thirty years.

Since the counterbalancing function is crucial for a FOWT platform under both normal conditions (such as regular operation and extreme conditions) and abnormal conditions (such as hull tank flooding, emergency shutdowns, and other scenarios), losing this capability could result in reduced power production efficiency, loss of structural integrity, or even capsizing. The method in this embodiment incorporates redundancy: during operations, both sets of counterbalancing systems are active. In the event of inspection, maintenance, or if one set fails, the other set continues to operate, thereby enhancing overall reliability.

### SUMMARY OF THE INVENTION

In FIG. 3, the method of the present embodiment is designed to counterbalance the mean inclination of the FOWT platform. The FOWT platform is supported by three columns (North column, Southwest column, and Southeast column) positioned apart, and these columns are equipped with systems for adjusting water levels to counterbalance the inclination. The platform will experience six degrees of freedom (6-DOF) motions, which will be measured by devices on board in real time. The platform's inclination is continuously monitored and measured, with data consisting of both mean and dynamic inclinations. This real-time measurement data is transmitted to the command center. Based on project experience and design criteria, a threshold value for mean inclination is pre-established, representing the maximum acceptable mean tilt for optimal WTG performance. If the mean inclination exceeds the predefined threshold, the counterbalancing system is activated to adjust the platform's orientation. The command center calculates the required amount of water to be pumped in or out of each column to correct the platform's tilt. Adjustments are made within each column independently, with water either pumped into the column to increase weight or pumped out to decrease weight, effectively addressing the inclination. If the mean inclination is below the threshold, the counterbalancing system remains inactive to conserve power, avoiding unnecessary adjustments that could impact power consumption without sacrificing the efficiency of wind power production.

In FIG. 3, the method of the present embodiment is designed to regulate ballasts within each column separately, thus avoiding large-scale ballast water transfers between columns. This strategy improves system responsiveness by allowing swift, localized adjustments to each column, thereby enhancing response time. Moreover, it cuts costs related to long-distance pipelines and reduces power consumption during ballast adjustments by removing the need for extensive water movement across the platform. As the trend toward deploying high-capacity WTGs advances, the distance between columns grows significantly. As a result, the drawbacks and inefficiencies of conventional ballast transfer methods become more evident, making this independent column adjustment approach increasingly crucial for preserving platform stability and operational efficiency.

In FIG. 4, two identical sets of pump-in and pump-out arrangements for the Southwest (SW) column are illustrated to explain the layout of the counterbalancing system and its operational philosophy. Each set includes both a pump-in arrangement and a pump-out arrangement. The pump-in arrangement features fill lines, a pump-in shut-down mechanism, a pump-in pump for introducing water into the column, and an intake valve to regulate the flow of water into the system. The pump-out arrangement consists of drain lines, a discharge valve to control water outflow, a pump-out pump for removing water from the column, and a pump-out shut-down mechanism to ensure safe operation. Each set operates independently of the other. This design ensures that if one set fails or requires inspection and maintenance, it does not impact the operation of the other set. This redundancy enhances the overall reliability of the system, ensuring that the column's ballast management remains effective and uninterrupted.

In FIG. 5, the communication flow between the two sets of pump-in and pump-out arrangements in the Southwest (SW) column and the command center is illustrated. The command center plays a crucial role in monitoring the platform's movements and issuing the necessary action signals for each column. These signals guide both sets of pump-in and pump-out arrangements within each column, specifying instructions for adding or removing water from each ballast tank. Additionally, the command center can issue shut-down commands if significant issues are detected. This system ensures that the platform's mean tilt and stability are actively managed, with timely corrective actions taken to maintain both operational efficiency and safety.

In FIG. 6, the layout of the Southwest (SW) column is illustrated, showcasing the two sets of pump-in and pump-out arrangements as well as the column's compartmentation. The column features two ballast tanks situated outwardly on the first level, with each set of pump-in and pump-out arrangements independently linked to these tanks. Four water level sensors are positioned along the walls of each ballast tank to provide accurate monitoring and measurements. These sensors continuously track the water levels and transmit real-time data to the command center for analysis. If the water levels in any ballast tank reach predefined minimum or maximum thresholds, shut-down signals are triggered to automatically deactivate the associated pumps and valves. This system helps prevent operational issues by maintaining the ballast tanks within safe and optimal water level ranges.

In FIG. 7, the current embodiment of the two sets of pump-in and pump-out arrangements for the Southwest (SW) column is illustrated. The system comprises fill lines and drain lines that are connected to each ballast tank. These lines extend upward through a central access shaft, traverse over the top of the column, and then descend along the column's outer shell, reaching the platform keel level. This configuration allows for the adjustment of water volumes pumped into or out of each ballast tank, which can be the same or vary according to specific needs as directed by signals from the command center. This flexibility ensures that the system can effectively respond to both normal operating conditions and unusual scenarios, thus providing optimal stability and adaptability for the platform.

In FIG. 8, the current embodiment of the arrangements for the two ballast tanks in the Southwest (SW) column is depicted. These ballast tanks, located outwardly on the first level of the column, are each linked to their respective fill and drain lines through the central access shaft. Inside each tank, four water level sensors are positioned along the walls to measure the water level at various points within the tank. The data collected by these sensors are transmitted to the command center, where they are used to determine the total volume of water in each ballast tank. This detailed monitoring facilitates accurate tracking of water levels and improves the system's capability to control ballast effectively.

### BRIEF DESCRIPTION OF DRAWINGS

FIG. 1 depicts the thrust loads and overturning moments of a 15 MW wind turbine generator (WTG) as functions of wind speed.

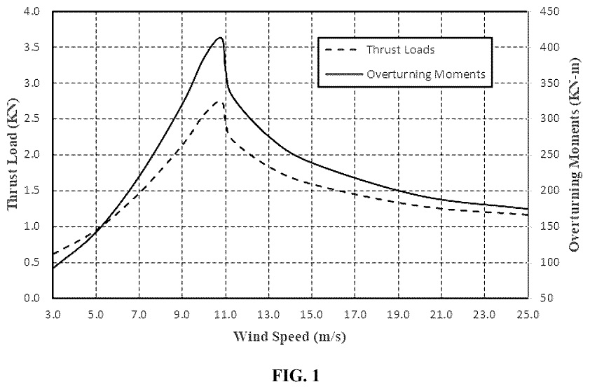

FIG. 2 illustrates a diagram of the ballast transfer system (prior art).

FIG. 3 displays a diagram of the present embodiment of the counterbalancing method, the top view shown above and the elevation view below.

FIG. 4 shows section views of the SW column for the present embodiment, with the A-A view on the left and the B-B view on the right.

FIG. 5 displays an enlarged diagram of the present embodiment, showing the signal exchanges between the command center and the SW column.

FIG. 6 illustrates the layout of the SW column for the present embodiment and its compartmentation, with the outer shell of the column removed for illustration purposes.

FIG. 7 depicts the present embodiment of the pump-in and pump-out arrangements for the SW column, with the pump-in arrangement on the left and the pump-out arrangement on the right.

FIG. 8 illustrates the current embodiment of the arrangements in the ballast tanks of the SW column, showing views from both the Southwest (left) and the Northeast (right).

### DETAILED DESCRIPTION

The FOWT platform is supported by three columns 101 (North column, Southwest column, and Southeast column), each positioned apart and outfitted with systems designed to regulate water levels to counterbalance the platform's mean inclination. The platform undergoes six degrees of freedom (6-DOF) motions, which are constantly tracked in real time by onboard motion sensors. These real-time motion signals 104 are relayed to command center 105 for processing and interpretation. Based on project experience and design specifications, a threshold value for mean inclination is set, representing the maximum acceptable tilt for optimal WTG performance. If the mean inclination exceeds this threshold, the counterbalancing system is triggered to correct the platform's orientation. Command center 105 determines the required amount of water to be introduced or removed from each column 101 to rectify the platform's tilt. Adjustments are carried out within each column 101 separately, with water either added to increase weight or extracted to decrease weight, effectively managing the inclination. If the mean inclination remains below the threshold, the counterbalancing system remains dormant to save power, preventing unnecessary adjustments that could affect power consumption while preserving wind power production efficiency.

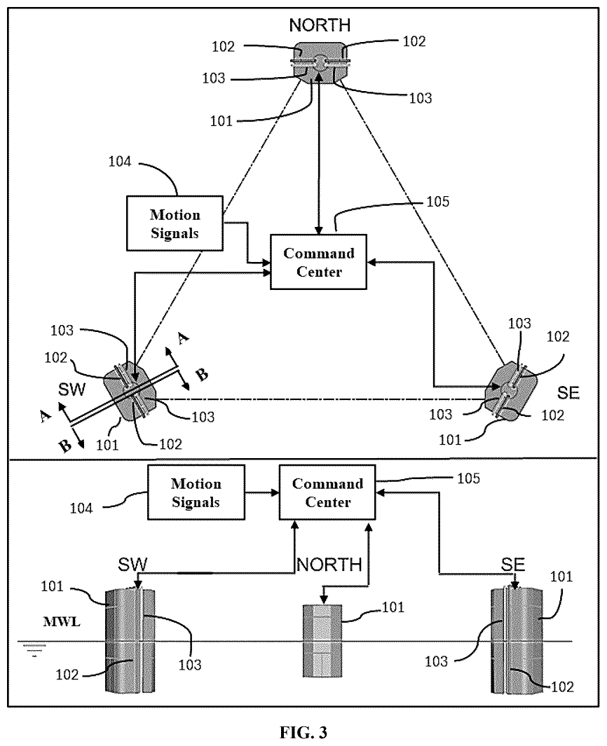

In FIG. 3, real-time motion signals 104 are sent to command center 105 for thorough analysis. Each column 101 is outfitted with two sets of drain lines 102 and fill lines 103, with no interconnections for drain 102 or fill 103 lines between the columns. Command center 105 is essential for overseeing the platform's movements and issuing the necessary action signals to manage both individual columns 101 and the entire platform. These action signals are directed to both sets of pump-in and pump-out systems within column 101 to quickly counteract the platform's mean tilt. Specifically, the signals regulate the volume of water to be introduced or removed from each ballast tank within the same column 101 and coordinate the water volumes across the columns 101 to ensure the platform's mean inclination remains below the specified threshold. Additionally, command center 105 can issue shut-down commands if critical issues are detected. This configuration guarantees that the platform's stability is continuously monitored and that timely corrective measures are taken to maintain operational efficiency and safety.

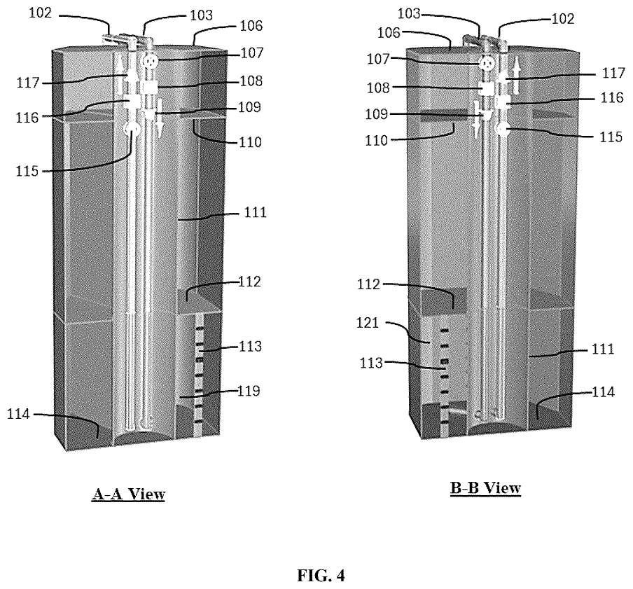

In FIG. 4, the arrangement of the pump-in and pump-out systems for the Southwest (SW) column 101 is depicted, providing insight into the counterbalancing system's design and operational mechanisms. Each column 101 consists of four horizontal watertight plates: the keel plate 114, the first plate 112, the second plate 110, and the top plate 106. A central access shaft 111 is integrated into each column 101. The current configuration includes two sets of counterbalancing systems, with each set comprising both a pump-in system and a pump-out system connecting to perspective ballast tank (119 or 121). These systems are housed within the central access shaft 111. The pump-in system incorporates a pump-in shut-down mechanism 107, a pump-in pump 108 for adding water to column 101, and an intake valve 109 to manage the water inflow into the column. Conversely, the pump-out system includes a discharge valve 115 for controlling water outflow, a pump-out pump 116 for removing water from column 101, and a pump-out shut-down mechanism 117 to ensure safe operation.

The pump-in and pump-out arrangements shown in both the A-A view and B-B view are identical, with each set operating independently. This design guarantees that a failure or maintenance issue affecting one set does not impair the functionality of the other set. This redundancy enhances the overall reliability of the system, ensuring effective and continuous ballast management within column 101.

The SW column 101 houses two ballast tanks: ballast tank 119, visible in the A-A view, and ballast tank 121, shown in the B-B view. Each ballast tank (119 or 121) is equipped with four water level sensors 113, which continuously track and transmit data on the water levels within each respective tank. This arrangement enables precise monitoring of water volume, facilitating timely adjustments to maintain the platform's mean tilt and overall stability.

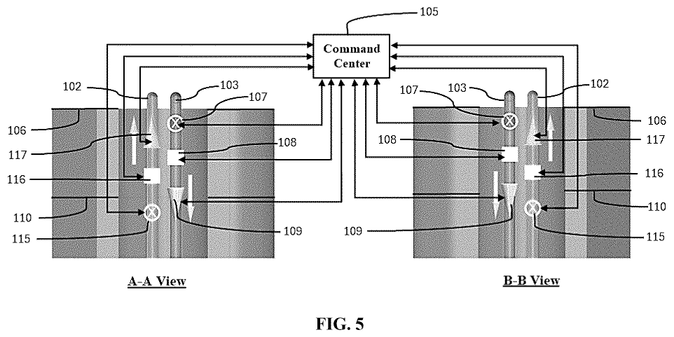

In FIG. 5, the communication flow between all equipment components—namely the pumps, valves, and shut-down mechanisms—of the two sets of counterbalancing systems in the central access shaft 111 of the Southwest (SW) column 101 and the command center 105 is illustrated. Each set, positioned near the top of column 106, is depicted in the A-A view, while the other identical set is shown in the B-B view. The North and Southeast columns 101 are equipped with identical counterbalancing systems, which are standard across the design and interchangeable. The pump-in system comprises a pump-in shut-down mechanism 107, a pump-in pump 108, and an intake valve 109. Conversely, the pump-out system includes a discharge valve 115, a pump-out pump 116, and a pump-out shut-down mechanism 117. These components are strategically located near the top of column 106 to simplify access, inspection, and maintenance.

Command center 105 transmits control signals to both sets of counterbalancing systems within each column 101. This real-time communication enables effective management of the platform's counterbalancing system, ensuring that operations are carried out efficiently and safely.

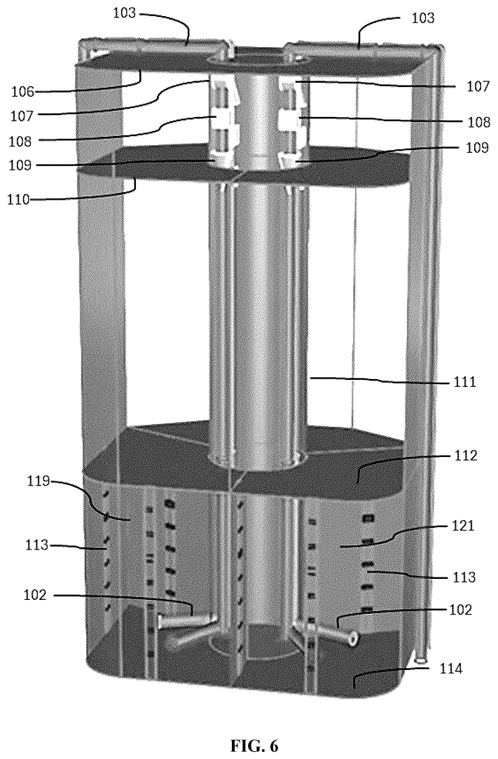

In FIG. 6, the layout of the Southwest (SW) column 101 is depicted, showcasing the arrangement of the two sets of counterbalancing systems along with the column's compartmental structure. Each set of counterbalancing systems comprises one pump-in and one pump-out arrangement, each connected to a specific ballast tank (119 or 121). The SW column 101 contains two ballast tanks, labeled 119 and 121, positioned outwardly between the keel plate 114 and the first plate 112. Each set of pump-in and pump-out systems is independently connected to its respective ballast tank (119 or 121).

Within each ballast tank, four water level sensors 113 are installed along the walls. These sensors continuously measure the water levels and send real-time data to the command center 105 for processing and interpretation. When the water levels in any ballast tank (119 or 121) reach the predefined minimum or maximum thresholds, the associated shut-down mechanisms (107 and/or 117) are activated. This triggers the automatic shutdown of the relevant pumps (108 or 116) and valves (109 or 115). By maintaining the water levels within safe and optimal ranges, the system prevents operational issues and ensures that the platform's mean tilt remains within the prescribed limits. This proactive management guarantees both stability and efficient performance of the platform.

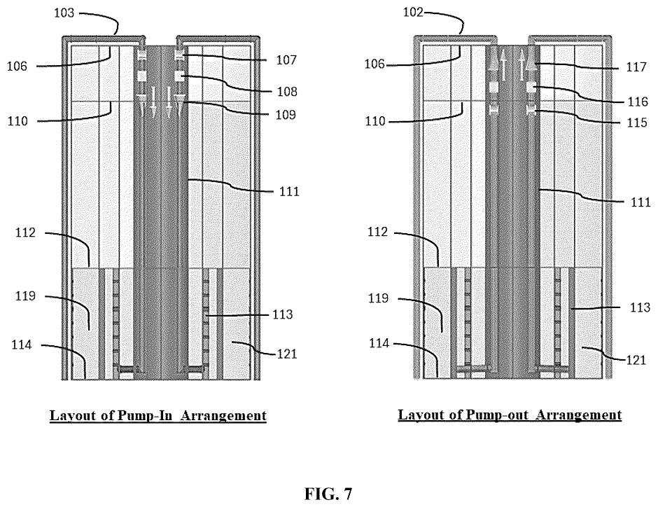

In FIG. 7, the current embodiment of the two sets of pump-in and pump-out arrangements for the Southwest (SW) column 101 is illustrated. This configuration incorporates fill lines 103 and drain lines 102, each connecting to the respective ballast tanks (119 or 121). The lines rise through the central access shaft 111, traverse over the top of column 106, and then descend along the outer shell of column 101, ending at the platform keel level.

This setup provides the flexibility to either maintain uniform water levels across each ballast tank (119 or 121) within the same column 101 or adjust them as needed based on the directives from the command center 105. This adaptability is crucial for managing both standard operational conditions—such as changes in wind speed and direction under normal and severe sea states—and exceptional situations, including scenarios where tanks are flooded or emergency shutdowns are required.
By facilitating precise control and rapid adjustments, this system significantly enhances the platform's responsiveness, stability, and flexibility. This capability ensures that the platform remains effective and maintains strong operational performance across a wide range of conditions and scenarios.

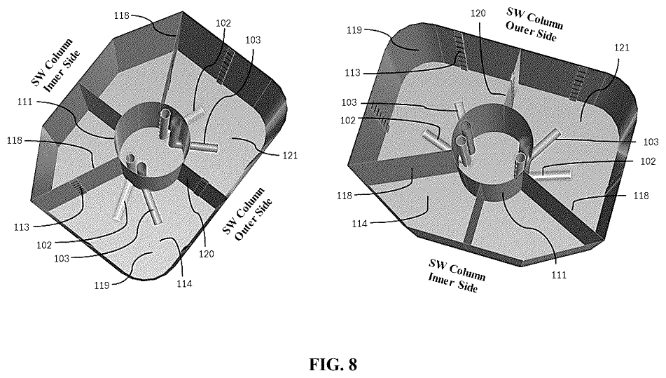

In FIG. 8, the configuration of the ballast tanks within the Southwest (SW) column 101 is depicted. The column accommodates two ballast tanks, designated as 119 and 121, positioned outwardly between the keel plate 114 and the first plate 112. Each ballast tank (119 or 121) is divided by two vertical plates: plate 118 separates each tank from the adjacent compartment, while plate 120 is placed between the two ballast tanks (119 and 121).

Each counterbalancing system is dedicated to its specific ballast tank (119 or 121). Each system features pump-in and pump-out arrangements that connect to their respective ballast tanks via the central access shaft 111. Inside each ballast tank (119 or 121), four water level sensors 113 are installed along the inner walls. These sensors 113 continuously monitor and record water levels at various points within the tank, providing a detailed measurement of the water volume.
Data collected from these sensors 113 is transmitted to command center 105, where it is analyzed to determine the total water volume in each ballast tank (119 or 121). This precise and continuous monitoring enables accurate tracking of water levels, allowing for effective ballast management and ensuring the stability of the platform. By maintaining optimal water levels, the system enhances the platform's ability to adapt to changing conditions and maintain operational stability.

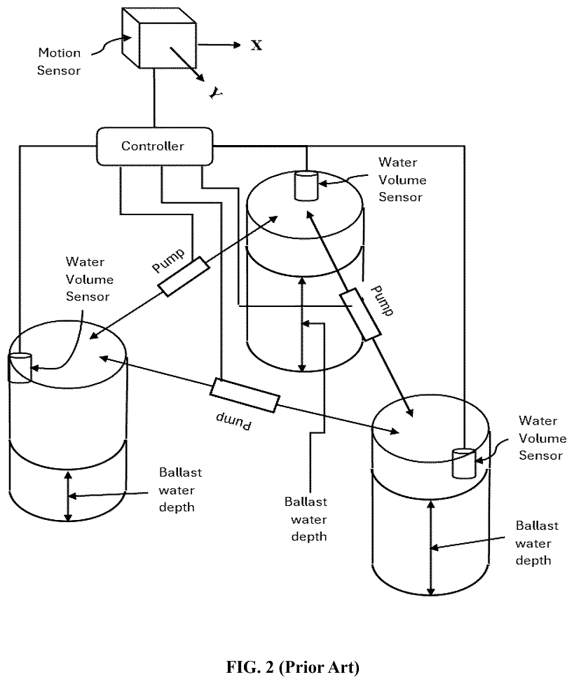

This embodiment is engineered to deliver quick response times and to avoid slow response time (15-30 minutes per U.S. Pat. No. 8,471,396 B2) associated with lengthy ballast transfers between columns, as illustrated in FIG. 2. The design focuses on performing pump-in and pump-out operations within the same column 101, directed by action signals from command center 105,

1. A method for counterbalancing the mean inclination of a Floating Offshore Wind Turbine (FOWT) platform with three columns, comprising:
one command center; and
six sets of pump-in arrangements; and
six sets of pump-out arrangements; and
twenty-four water level sensors.

2. The method of claim 1, wherein the command center is responsible for processing the platform's movement signals as well as monitoring the water levels in each ballast tank through water level sensors, with collected data being processed and transmitted to it in real-time. The command center has a built-in threshold value for mean inclination based on project experience and design criteria. By comparing the mean inclination from the real-time measurements of the platform's movements, if the mean inclination exceeds the predefined threshold, the counterbalancing system is activated to adjust the platform's orientation. To counterbalance the mean tilt of the platform below the threshold, the command center calculates the optimal amounts of water to be pumped in or out of each ballast tank from three columns to correct the platform's tilt. Adjustments per action signals regulate the volume of water to be introduced or removed from each ballast tank within the same column independently and coordinate the water volumes across the columns to ensure the platform's mean inclination remains below the specified threshold. With water either pumped into the column to increase weight or pumped out to decrease weight, effectively addressing the inclination. If the mean inclination is below the threshold, the counterbalancing system remains inactive to conserve power, avoiding unnecessary adjustments that could impact power consumption without sacrificing the efficiency of wind power production.

3. The method of claim 1, wherein the command center is equipped with the capability to deploy shut-down commands to any of the pump-in or pump-out arrangements if critical issues or malfunctions are detected. This feature ensures that the system can quickly respond to severe problems to prevent damage or unsafe conditions. Additionally, the command center supports remote operation, which enables operators to control and monitor the system from a distance. This remote capability provides enhanced flexibility and convenience, allowing for real-time adjustments and oversight without being physically present. Together, these features significantly improve the overall flexibility, operational efficiency, and safety of the ballast control system.

4. The method of claim 1, wherein six sets of pump-in arrangements are distributed across three columns, with two sets of pump-in arrangements being identical and installed within the same column. Each set of pump-in arrangements is connected to a respective ballast tank. Additionally, two sets of pump-in arrangements are connected to independent ballast tanks, respectively. There is no interconnection of pump-in arrangements between ballast tanks or between columns. This configuration ensures that each column contains at least two sets of pump-in arrangements, with each set coupled to an independent and respective ballast tank. This setup is designed to effectively manage water distribution and balance, preventing any cross-communication between tanks or columns.

5. The method of claim 1, wherein six sets of pump-out arrangements are allocated across three columns, with two sets of pump-out arrangements being identical and positioned within the same column. Each set of pump-out arrangements is linked to a respective ballast tank.
Additionally, two sets of pump-out arrangements are attached to independent ballast tanks, respectively. There is no interconnection of pump-out arrangements between ballast tanks or across columns. This arrangement guarantees that each column includes at least two sets of pump-out arrangements, with each set associated with an independent and respective ballast tank. This design is intended to efficiently regulate water distribution and balance, avoiding any cross-communication between tanks or columns.

6. The method of claim 1, wherein one set of pump-in arrangements and one set of pump-out arrangements together form a single counterbalancing system. Each counterbalancing system is connected to an independent and respective ballast tank, while the other counterbalancing system is connected to a different independent and respective ballast tank. This arrangement enables coordinated management of water levels in each ballast tank independently, without interference between them, to maximize flexibility and deliver a fast and optimal solution.

7. The method of claim 1, wherein twenty-four water level sensors are installed on the respective side walls of six ballast tanks distributed across the three columns. Each column contains two identical ballast tanks, and four water level sensors are placed on each of the four walls within a single ballast tank to monitor water level variations in real time. The data collected by these sensors is sent to the command center for processing and analysis.

8. The method of claim 4, wherein one set of pump-in arrangements includes fill lines, a pump-in shut-down mechanism, a pump-in pump designed for introducing water into the column, and an intake valve that controls the flow of water into the system. The fill line extends from the ballast tank, rising through a central access shaft, running over the top of the column, descending along the outer shell of the column, and ending at the platform keel level.

9. The method of claim 5, wherein one set of pump-out arrangements includes drain lines, a discharge valve to regulate the outflow of water, a pump-out pump designed for removing water from the column, and a pump-out shut-down mechanism to ensure safe operation. The drain line extends from the ballast tank, rising through a central access shaft, running over the top of the column, descending along the outer shell of the column, and terminating at the platform keel level.

10. A method for providing redundancy of the counterbalancing function for a FOWT platform comprising:
one command center; and
three columns; and
six ballast tanks; and
six pairs of counterbalancing systems.

11. The method of claim 10, wherein, upon receiving action signals indicating a malfunction or maintenance issue with the counterbalancing system in one column, the command center will recalculate and adjust the water volume for the remaining counterbalancing system and its associated ballast tank. The water volumes for the other four counterbalancing systems and their respective ballast tanks will also be recalculated and adjusted accordingly to ensure a rapid response and optimal distribution of water ballast.

12. The method of claim 10, wherein the three columns of the FOWT platform are identical and spaced apart, with each column equipped with at least two identical sets of counterbalancing systems designed to adjust water levels in independent and respective ballast tanks to counterbalance the mean inclination of the FOWT platform. Upon receiving action signals indicating a malfunction or maintenance, the command center will issue recalculated and adjusted action signals to each set of the remaining counterbalancing systems associated with the respective ballast tanks within the affected column as well as the other two unaffected columns. This setup ensures effective management of the platform's stability, even during a malfunction or maintenance situation.

13. The method of claim 10, wherein the six ballast tanks are distributed across the three columns, with two ballast tanks per column. Each column contains two ballast tanks positioned outwardly between the keel plate and the first plate. Each ballast tank is divided by two vertical plates: one vertical plate separates the ballast tank from an adjacent tank, and the other vertical plate is positioned between the two ballast tanks within the same column. These two ballast tanks are independent, and each is coupled with a respective set of counterbalancing systems.

14. The method of claim 10, wherein the six pairs of counterbalancing systems are distributed within the three columns, with two pairs per column. Each pair consists of both a pump-in arrangement and a pump-out arrangement. Each pair is connected to a corresponding ballast tank, allowing for precise control from command center over water levels within each tank.

15. The method of claim 10, wherein each pair of pump-in and pump-out arrangements is connected to an independent, corresponding ballast tank. Each column contains two identical ballast tanks and two pairs of identical counterbalancing systems. Each set of pump-in and pump-out arrangements operates independently of the others. This configuration ensures that if one set fails or requires maintenance, it does not impact the functionality of the remaining sets. This redundancy enhances the overall reliability of the system, ensuring that the platform's ballast management remains effective and continuous.
